(19) United States
(12) Patent Application Publication
(10) Pub. No.: US 2020/0117380 A1
(43) Pub. Date: Apr. 16, 2020

(54) MEMORY DEVICE AND CONTROL METHOD

(71) Applicant: RayMX Microelectronics, Corp., Anhui province (CN)

(72) Inventors: Yen-Chung CHEN, Zhubei City (TW); Han-Ting TSAI, Taipei City (TW); Jiunn-Jong PAN, Zhubei City (TW); Wei-Ren HSU, Taipei City (TW)

(21) Appl. No.: 16/525,660

(22) Filed: Jul. 30, 2019

(30) Foreign Application Priority Data
Oct. 15, 2018 (TW) 107136234

(51) Int. Cl. G06F 3/06

(52) U.S. Cl. CPC G06F 3/0644; G06F 3/0673; G06F 3/0659; G06F 3/0604

(57) ABSTRACT

A memory device includes a data calculation circuit, a space calculation circuit, and a warning circuit. The data calculation circuit is coupled to a memory, and is configured to determine a data quantity of valid data stored in the memory. The space calculation circuit is coupled to the memory, and is configured to determine a data capacity of a current valid storage space of the memory. The warning circuit is configured to determine a threshold capacity according to the data quantity, and is configured to determine whether to output a warning message according to the data capacity, the data quantity, and the threshold capacity.

### RELATED APPLICATIONS

This application claims priority to Taiwan Application Serial Number 107136234, filed Oct. 15, 2018, which is herein incorporated by reference.

### BACKGROUND

### Technical Field

The present disclosure relates to a memory device. More particularly, the present disclosure relates to a memory device and a control method that dynamically monitor user data and damaged storage block(s).

### Description of Related Art

Flash memory (e.g., NAND flash memory) is an electronic non-volatile storage medium that can be electrically erased and reprogrammed. The storage devices (e.g., Solid state disk (SSD), Memory Card) including many flash memories have been widely used. Manufacturers of the storage device need to set a preset fixed storage spaces on storage devices (e.g., 120 G, 128 G, 240 G . . . etc.).

Writing data to the NAND memory is by moving the valid data in the small memory block. Since it is moving, it must have the effect of freeing up old areas and writing new data. If the valid data is approximately equal to the total sum of the blocks can be stored, so the action of freeing up the old area cannot be performed, so the storage device is no longer able to accept new data. In general, with increasing of operating time of the storage device, the storage device may have more and more damaged storage blocks. If the number of the damaged storage blocks in the storage device is too much to make the storage device be unable to reallocate the stored data, such that the storage device is unable to program new data. Under this condition, this storage device is considered as end-of-life.

### SUMMARY

Some aspects of the present disclosure are to provide a memory device that includes a data calculation circuit, a space calculation circuit, and a warning circuit. The data calculation circuit is coupled to a memory and is configured to determine a first data quantity of valid data stored in the memory. The space calculation circuit is coupled to the memory and is configured to determine a first data capacity of a current valid storage space of the memory. The warning circuit is configured to determine a threshold capacity according to the first data quantity, and to determine whether to output a warning message according to the first data capacity, the first data quantity, and the threshold capacity.

Some aspects of the present disclosure are to provide a control method for controlling a memory device, and the control method includes the following operations: determining a first data quantity of valid data stored in the memory; determining a first data capacity of a current valid storage space of the memory; determining a threshold capacity according to the first data quantity; and determining whether to output a warning message according to the first data capacity, the first data quantity, and the threshold capacity.

As described above, the memory device and the memory provided in embodiments of the present disclosure are able to dynamically monitor user data and damaged storage space, in order to instantly notify the user whether to delete his/her data. As a result, the service life of the memory is extended.

### BRIEF DESCRIPTION OF THE DRAWINGS

FIG. 1 is a schematic diagram of a memory device according to some embodiments of the present disclosure.

FIG. 2 is a schematic diagram of another operating state of the memory in FIG. 1, according to some embodiments.

FIG. 3 is a flowchart of a control method, according to some embodiments of the present disclosure.

### DETAILED DESCRIPTION

The terms used in this specification generally have their ordinary meanings in the art, within the context of the present disclosure, and in the specific context where each term is used. The use of examples anywhere in this specification including examples of any terms discussed herein is illustrative only, and in no way limits the scope and meaning of the present disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other.

In this document, the term “circuitry” may indicate a system formed with one or more circuits. The term “circuit” may indicate an object, which is formed with one or more transistors and/or one or more active/passive elements based on a specific arrangement, for processing signals.

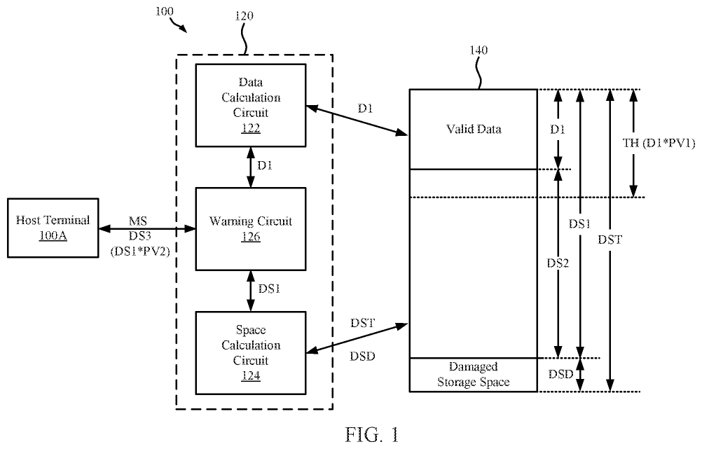

Reference is made to FIG. 1. FIG. 1 is a schematic diagram of a storage device 100 according to some embodiments of the present disclosure. In some embodiments, the storage device 100 includes a controller circuitry 120 and at least one non-volatile memory 140. In some embodiments, the storage device 100 may be a solid state disk (SSD). For example, the memory 140 may be a flash memory. In some other embodiments, the flash memory includes NAND flash memory. The implementations of the memory 140 are given for illustrative purposes, and various types of the memory 140 are within the contemplated scope of the present disclosure.

In some embodiments, the memory 140 includes storage blocks (not shown) that can be written with data in sequence under control of the controller circuitry 120. In some embodiments, the storage blocks may be memory blocks, pages, etc. With increasing of the operating time, a certain part of the storage blocks may be damaged, and thus are unable to provide the function of reading/writing data. In some embodiments, the certain part of the storage blocks are referred to as “damaged storage space.”

In some embodiments, the controller circuitry 120 includes a data calculation circuit 122, a space calculation circuit 124, and a warning circuit 126. The data calculation circuit 122 and the space calculation circuit 124 are coupled to the memory 140, in order to acquire related information of the memory 140.

In some embodiments, the data calculation circuit 122 is configured to determine whether storage blocks of the memory 140 have valid data stored. If the storage blocks have the stored valid data, the data calculation circuit 122 considers the stored data as valid data before these storage blocks are trimmed, and accumulates data quantity of the stored data to determine a data quantity D1. Alternatively, in some embodiments, the data calculation circuit 122 is coupled to a register (not shown) and/or an associated controller circuit (not shown) of the memory 140, in order to directly acquire information of the data quantity D1 of the valid data. The register is for indicating whether the storage blocks of the memory 140 are storing data. If the storage blocks of the memory 140 are storing the data, the data stored in the storage blocks are considered as the valid data. For example, the memory 140 have a plurality of corresponding register for recording whether the corresponding storage units are valid (data has been written in the storage units), wherein capacity of the plurality of storage units can be 4K, 8K, 16K, . . . etc. The calculation circuit 122 can obtain the data amount D1 of the valid data according to the capacity of the storage unit and the number of registers in which the record is valid data.

The determinations of the data quantity D1 of the valid data are given for illustrative purposes, but the present disclosure are not limited thereto. Various calculations able to be applied to the memory device 100 are with the contemplated scope of the present disclosure.

The calculation of the effective space is to accumulate the total number of all functional storage units, and the total number can be obtained. In an embodiment, the space calculation circuit 124 may be coupled to the register that record whether the function of corresponding storage unit is normal and/or related circuit(s) in the memory 140, in order to acquire related information. For example, in some embodiments, the space calculation circuit 124 may acquire information, including a total data capacity DST of the memory 140 and a data capacity DSD of the damaged storage space in the memory 140, from the memory 140.

In some embodiments, the space calculation circuit 124 determines a data capacity DS1 of valid storage space of the memory 140 according to the total data capacity DST and the data capacity DSD. In some embodiments, as shown in FIG. 1, the space calculation circuit 124 may determine the data capacity DS1 according to a difference between the total data capacity DST and the data capacity DSD. In some embodiments, the data capacity DS1 indicates an actual data capacity of undamaged storage space (i.e., the valid storage space, which includes storage blocks storing valid data and storage blocks not storing data) of the memory 140.

For example, the total data capacity DST may be 128 gigabyte (GB), and the data capacity DSD may be about 10 GB. The space calculation circuit 124 thus determines that the data capacity DS1 of the valid storage space in the memory 140 is 118 GB. The above values are given for illustrative purposes, and the present disclosure is not limited thereto.

The warning circuit 126 is coupled to the data calculation circuit 122 and the space calculation circuit 124, in order to receive information including the data quantity D1 and the data capacity DS1. In some embodiments, the warning circuit 126 is configured to determine a threshold capacity TH according to the data quantity D1, and determine whether to output a warning message MS to a host 100A according to the data capacity DS1, the data quantity D1, and the threshold capacity TH. In some embodiments, the warning message MS is for verifying whether to reduce the data quantity D1 of the valid data.

In some embodiments, as shown in FIG. 1, the warning circuit 126 may multiply the data quantity D1 and a predetermined value PV1, in order to determine the threshold capacity TH1 according to a product of the data quantity D1 and the predetermined value PV1. In some embodiments, the predetermined value PV1 may be any value greater than 1. For example, the predetermined value PV1 may be 1.1, and the threshold capacity of TH may be 1.1 times of the data quantity D1. The above values are given for illustrative purposes, and the present disclosure is not limited thereto.

In some embodiments, the warning circuit 126 may determine a valid data capacity DS2 according to a difference value between the data capacity DS1 and the data quantity D1. In greater detail, as described above, the data capacity DS1 indicates the data capacity of undamaged storage space in the memory 140. Thus, by subtracting the data quantity D1 of the stored valid data from the data capacity DS1, the warning circuit 126 is able to acquire the data capacity of remaining storage space, which is able to store data, in the memory 140 (i.e., the valid data capacity DS2).

In some embodiments, if the valid data capacity DS2 is greater than or equal to the threshold capacity TH, the warning circuit 126 does not send the warning message MS to the host 100A.

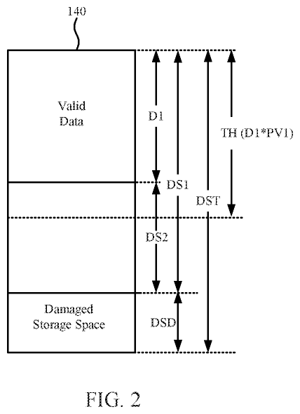

Alternatively, reference is also made to FIG. 2, and FIG. 2 is a schematic diagram of another operating state of the memory 140 in FIG. 1, according to some embodiments. As shown in FIG. 2, compared with FIG. 1, the data quantity D1 of the stored data in the memory 140 is increased, and the data capacity DSD of the damaged storage space is increased as well. Under this condition, the valid data capacity DS2 is reduced, and the threshold capacity TH is increased. If the valid data capacity DS2 is lower than the threshold capacity TH, the warning circuit 126 sends the warning message MS to the host 100A. Accordingly, the host 100A may notify a user through an output interface (which may be a display, a speaker, etc.). As a result, the user may determine whether to reduce the data quantity D1 of the valid data according to the warning message MS. The notifications of the warning message MS are given for illustrative purposes, and various types of the notification are within the contemplated scope of the present disclosure.

In some embodiments where the memory 140 is a flash memory, a data programming management of the memory 140 includes garbage collection. In the garbage collection, the memory 140 keeps at least one storage block (which, for example, may be storage block(s) corresponding to the data capacity DS2) being empty, in order to reallocate the valid data. As a result, the storage blocks storing data can be released, in order to store new data.

As more and more data is written, or as more and more accesses are made, the amount of data or the damaged storage blocks of valid data will increase. As a result, a remaining valid data capacity in a flash memory is reduced. Once the valid data capacity is sufficiently low to cause a malfunction of the garbage collection, the flash memory enters to a read-only mode. Under this condition, the flash memory is considered as end-of-life. However, the controller circuitry 120 of the embodiment of the present invention can instantly and dynamically monitor the data amount D1 of the valid data and the data capacity DSD of the damaged storage space to instantly determine the critical capacity TH and the effective data capacity DS2.

However, the controller circuitry 120 in some embodiments of this invention can instantly and dynamically monitor the data quantity D1 of the valid data and the data capacity DSD of the damaged storage space, in order to instantly determine the threshold capacity TH and the valid data capacity DS2. By comparing the threshold capacity TH with the valid data capacity DS2, the controller circuitry 120 is able to send the warning message to notify the user that the data quantity D1 of the valid data should be reduced (e.g., deleting partial data, which are seldom used, from the valid data), in order to release storage blocks for reallocating data. As a result, the memory 140 is assured to have sufficient storage blocks for garbage collection, in order to extend a service life of the memory 140. That is to say, through the mechanism of the present invention, it is ensured that the memory 140 has a usable memory block capacity larger than the capacity required for garbage collection.

With continued reference to FIG. 1, in some embodiments, the warning circuit 126 is further configured to determine a data quantity DS3 according to the data quantity DS1, and to show information of the data quantity DS3 in the warning message MS1. Under this condition, the warning message MS1 is further configured to notify the user to determine whether to delete partial data from the valid data, in which a data quantity of the partial data equals to the data quantity DS3. For example, in some embodiments, the warning circuit 126 may determine the data quantity DS3 according to a product of the data quantity DS1 and a predetermined value PV2. For example, the data quantity DS1 is 50 GB, and the predetermined value PV2 is 0.2. Under this condition, the data quantity DS3 is 10 GB. Accordingly, the host terminal 100A may notify a user by the warning message MS through the output interface. The user may determine whether to delete 10 GB of the partial data from the valid data, in order to keep the memory 140 having more valid storage space.

In one embodiment, the warning message MS is displayed through a graphical interface, the warning message MS includes suggestions for reducing the amount of data, and/or a list of suggestion removable files generated based on the non-system file (eg, *.jpg, *.bmp, (image files), *.mp3, (music files), *.mp4 (video files), etc.) and/or cold data file (e.g. data file that has not been accessed for a long time).

The above values are given for illustrative purposes, and the present disclosure is not limited thereto. In some embodiments, the predetermined value PV2 may be any value greater than 0 and less than 1.

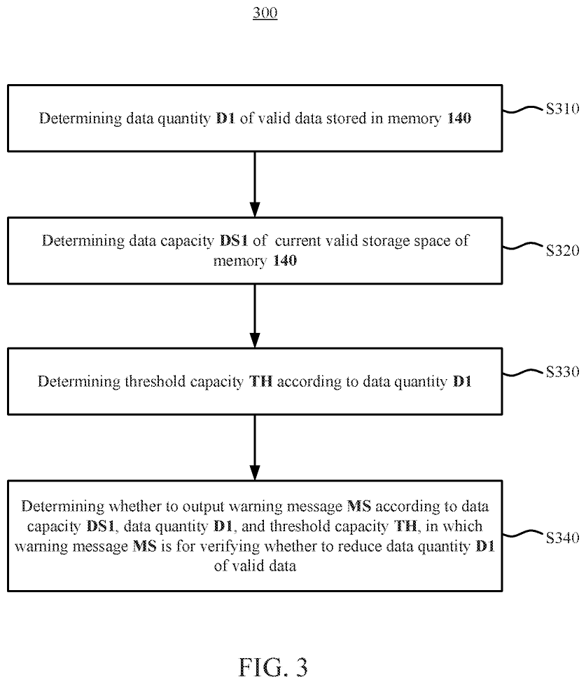

Reference is now made to FIG. 3. FIG. 3 is a flowchart of a control method 300, according to some embodiments of the present disclosure. In some embodiments, the control method 300 may be applied to the memory device 100, but the present disclosure is not limited thereto. In some embodiments, the control method includes operations S310, S320, S330, and S340.

In operation S310, the data quantity D1 of valid data stored in the memory 140 is determined. For example, as shown in FIG. 1, the data calculation circuit 122 is coupled to the memory 140, in order to determine the data quantity D1 of the valid data.

In operation S320, the data capacity DS1 of a current valid storage space of the memory 140 is determined. For example, as shown in FIG. 1, the space calculation circuit 124 may acquire the total data capacity DST and the data capacity DSD from the memory 140, and determine the data capacity DS1 according to the total data capacity DST and the data capacity DSD.

In operation S330, the threshold capacity TH is determined according to the data quantity D1. For example, as shown in FIG. 1, the warning circuit 126 may multiply the data quantity D1 and the predetermined value PV1, and determine the threshold capacity TH according to the product of the data quantity D1 and the predetermined value PV1.

In operation S340, whether to output the warning message MS is determined according to the data capacity DS1, the data quantity D1, and the threshold capacity TH, in which the warning message MS is for verifying whether to reduce the data quantity D1 of the valid data.

For example, as described above, the warning circuit 126 may determine the valid space capacity DS2 according the difference between the data capacity DS1 and the data quantity D1, and send the warning message MS to the host terminal 100A in response to the valid data capacity DS2 being less than the threshold capacity TH. Thus, a user is able to determine whether to reduce the data quantity D1 of the valid data according to the warning message MS. Alternatively, in response to the valid data capacity DS2 being greater than or equal to the threshold capacity TH, the warning circuit 126 does not send the warning message MS.

The above description of the control method 300 includes exemplary operations, but the operations of the control method 300 are not necessarily performed in the order described above. The order of the operations of the control method 300 can be changed, or the operations can be executed simultaneously or partially simultaneously as appropriate, in accordance with the spirit and scope of various embodiments of the present disclosure.

In various embodiments, the controller circuitry 120 may be implemented in hardware, software, and/or firmware. For example, various circuits or units in the controller circuitry 120 is able to be integrated into a single integrated circuit. In some embodiments, the controller circuitry 120 may be implemented with software that performs the control method 300. Alternatively, the controller circuitry 120 may be implemented with a digital signal processor circuit that performs the control method 300. In some other embodiments, various circuits or units in the controller circuitry 120 may be implemented with software, hardware, and firmware that cooperate with each other. Person skilled in the art may select the practical implementation of the controller circuitry 120 based on practical requirements.

As described above, the memory device and the memory provided in embodiments of the present disclosure are able to dynamically monitor user data and damaged storage space, in order to instantly notify the user whether to delete his/her data. When the total number of valid data increases is close to the total amount of effective space, these embodiments will notify the user through warning unit that the storage device has entered the endangered danger zone, prompting the user to delete some unused data and reduce the total number of effective data. The alert circuit also prompts the user for the total number of data to be deleted. When the user performs the delete action, the storage device will temporarily leave the end of life danger zone due to the reduction of the overall effective data volume. the storage device, which may have been near the end of its life, into a safe state for the purpose of extending the service life. As the usage time continues to increase, the warning unit will continue to remind the user as long as the user is willing and faithful to implement the warning unit recommendations. The storage device can continue to extend until the total number of valid spaces is low until the user decides to abandon the storage medium. As a result, the service life of the memory is extended.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A memory device, comprising:
a data calculation circuit coupled to a memory, the data calculation circuit configured to determine a first data quantity of valid data stored in the memory;
a space calculation circuit coupled to the memory, the space calculation circuit configured to determine a first data capacity of a current valid storage space of the memory; and
a warning circuit configured to determine a threshold capacity according to the first data quantity, and determine whether to output a warning message according to the first data capacity, the first data quantity, and the threshold capacity.

2. The memory device of claim 1, wherein the warning message comprises at least one of a suggestion for reducing the amount of data, and a list of suggestion removable files.

3. The memory device of claim 2, wherein the list comprises a non-system file.

4. The memory device of claim 1, wherein the space calculation circuit configured to acquire a total data capacity of the memory and a second data capacity of a current damaged storage space of the memory, and determine the first data capacity according to a difference between the total data capacity and the second data capacity.

5. The memory device of claim 1, wherein the warning circuit is further configured to determine a valid data capacity according to a difference between the first data capacity and the first data quantity, and the warning circuit outputs the warning message if the valid data capacity is less than the threshold capacity.

6. The memory device of claim 1, wherein the warning circuit is configured to determine the threshold capacity according to a product of the first data quantity and a predetermined value, wherein the predetermined value is greater than 1.

7. The memory device of claim 1, wherein the warning circuit is further configured to determine a second data quantity according to the first data quantity, in order to suggest whether to delete partial data having the second data quantity from the valid data.

8. The memory device of claim 7, wherein the warning circuit is configured to determine the second data quantity according to a product of the first data capacity and a predetermined value.

9. The memory device of claim 8, wherein the predetermined value is any value greater than 0 and less than 1.

10. A control method for controlling a memory, the control method comprising:
determining a first data quantity of valid data stored in the memory;
determining a first data capacity of a current valid storage space of the memory;
determining a threshold capacity according to the first data quantity; and
determining whether to output a warning message according to the first data capacity, the first data quantity, and the threshold capacity.

11. The control method of claim 10, wherein determining the first data capacity comprises:
acquiring a total data capacity of the memory and a second data capacity of a current damaged storage space of the memory; and
determining the first data capacity according to a difference between the total data capacity and the second data capacity.

12. The control method of claim 10, wherein determining whether to output the warning message comprises:
determining a valid data capacity according to a difference between the first data capacity and the first data quantity; and
if the valid data capacity is less than the threshold capacity, outputting the warning message.

13. The control method of claim 10, wherein determining the threshold capacity comprises:
determining the threshold capacity according to a product of the first data quantity and a predetermined value.

14. The control method of claim 13, wherein the predetermined value is greater than 1.

15. The control method of claim 10, further comprising:
determining a second data quantity according to the first data quantity, in order to suggest whether to delete partial data having the second data quantity from the valid data.

16. The control method of claim 15, wherein determining the second data quantity comprises:
determine the second data quantity according to a product of the first data capacity and a predetermined value.

17. The control method of claim 16, wherein and the predetermined value is any value greater than 0 and less than 1.

18. The control method of claim 10, wherein the warning message comprises at least one of a suggestion for reducing the amount of data, and a list of suggestion removable files.
